(19) United States
(12) Patent Application Publication
(10) Pub. No.: US 2011/0040912 A1
(43) Pub. Date: Feb. 17, 2011

(54) APPARATUS AND METHOD FOR MULTIPLE ENDIAN MODE BUS MATCHING

(75) Inventors: Kostantin Godin, Herzlia (IL); Moshe Anschel, Kfar Saba (IL); Jacob Efrat, Kfar Saba (IL); Itay Peled, Herzelia (IL); Reuven Badash, Petah Tikva (IL); Asher Bastaker, Raanana (IL); Dvir Rune Peleg, Tel Aviv (IL); Ziv Zamsky, Raanana (IL)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Austin, TX (US)

(21) Appl. No.: 11/575,003

(22) PCT Filed: Sep. 10, 2004
(86) PCT No.: PCT/EP2004/011078

§ 371 Date: Feb. 4, 2008

(51) Int. Cl. G06F 13/40; G06F 13/36

(52) U.S. Cl. 710/110; 710/311

(57) ABSTRACT

Apparatus and method for bus matching. The method includes: receiving data transfer characteristics at a first endian mode and at a second endian mode; determining a connectivity of multiple devices to an interfacing bus in response to the data transfer characteristics and in response to a relationship between a width of the interfacing bus and a width of each device interface; wherein at least one device interface is connected in parallel to multiple interfacing bus portions; and configuring a control logic such as to provide control signals representative of a transfer of data over the interfacing bus; whereas the control logic is configured in response to the connectivity. The apparatus includes: an interfacing bus characterized by an interfacing bus width; a master device, connected to the interfacing bus, whereas the master device includes a master device interface; multiple slave devices, each slave device connected to the interfacing bus and includes a slave device interface; wherein at least one slave device interface is connected in parallel to multiple interfacing bus portions; and control logic, connected to the interfacing bus and to the master device, the control logic is adapted to provide control signals representative of a transfer of data over the interfacing bus; whereas the control logic is configured in response to a connectivity of the multiple slave devices to the interfacing bus; whereas said connectivity is responsive to data transfer characteristics and is responsive to relationships between a width of the interfacing bus and a width of each device interface.

### FIELD OF THE INVENTION

The present invention relates to apparatuses and methods for bus matching, and especially for supporting multiple devices that are characterized by different bus widths and different endian modes.

### BACKGROUND OF THE INVENTION

Data can be organized in one of two types of data ordering modes—little endian mode and big endian mode. In a little endian mode the least significant portion (usually byte) of data is stored in a lower memory address than the most significant portion of the data. In a big endian mode the least significant portion (usually byte) of data is stored in a higher memory address than the most significant portion of the data.

Modern processor-based systems include multiple components such as processors, memory modules, interfaces and the like. Due to the increasing complexity of modern processor-based systems as well as the growing need to speed up the design process of these systems, there is a need to re-use as many hardware devices as possible and to re-use software components.

Various software components as well as hardware components can operate at a certain endian mode while others can operate at another mode. In order to interface between components of different endian mode various approaches were suggested. U.S. Pat. No. 5,828,853 of Regal, titled “Method and apparatus for interfacing between two systems operating in potentially differing endian modes”, U.S. Pat. No. 6,483,753 of Lin, titled “Endianess independent memory interface”, U.S. patent application 20010038348 of Suzuki et al titled “Endian conversion apparatuses and an endian conversion method in which a trouble is never induced in a recognition at a plural-byte unit without any delay in an endian process”, all incorporated herein by reference, provide an example of prior art apparatuses and methods for managing endian mode mismatch problems.

Connecting an interfacing bus having a interfacing bus width that differs than the width of an interface of a device that is connected to the interfacing bus can also involve wasting the memory space of the device as in many case this memory space is arranged in alignment to the interfacing bus width. For example, a byte-wide device connected to a word-wide interfacing bus can force the device to leave an empty byte between each pair of data bytes, in order to ensure that the device always writes the data byte to a predefined byte of the interfacing bus.

The complexity of interfacing between devices of different bus widths and of different endian modes is further increased when the interfacing bus does not align data to zero. The interfacing bus will convey a byte enable signal that determines the location of that data but devices that operate at differing endian modes interpret the same byte enable signal in different manners.

There is a need to provide systems and methods for interconnecting devices having different bus sizes and having different endian modes.

### SUMMARY OF THE PRESENT INVENTION

The invention provides a method for bus matching that allows connecting devices of various bus widths and different endian modes to an interfacing bus. Devices that have narrower buses than the interfacing bus are connected in parallel to various portions of the interfacing bus and a byte enable logic provide control signals that allow proper retrieval of data from the interfacing bus. The method does not require additional data multiplexers that are costly and slow the speed of the device.

### BRIEF DESCRIPTION OF THE DRAWINGS

The present invention will be understood and appreciated more fully from the following detailed description taken in conjunction with the drawings in which:

FIG. 1 is a schematic diagram of an apparatus that includes an interfacing device, according to an embodiment of the invention;

FIG. 2 is a schematic diagram of an apparatus that includes an interfacing device, according to another embodiment of the invention;

FIG. 3 is a flow chart illustrating a method for conveying data over an interfacing bus, according to an embodiment of the invention;

FIG. 4 is a flow chart illustrating a method for conveying data over an interfacing bus, according to an embodiment of the invention; and

FIG. 5 is a flow chart illustrating a method for bus matching, according to an embodiment of the invention.

### DETAILED DESCRIPTION OF PREFERRED EMBODIMENTS

The following description related to transferring bytes of data. Those of skill in the art will appreciate that the disclosed systems and methods can be applied mutates mutandis to data portions of different size and can also be applied to transferring addresses and address portions.

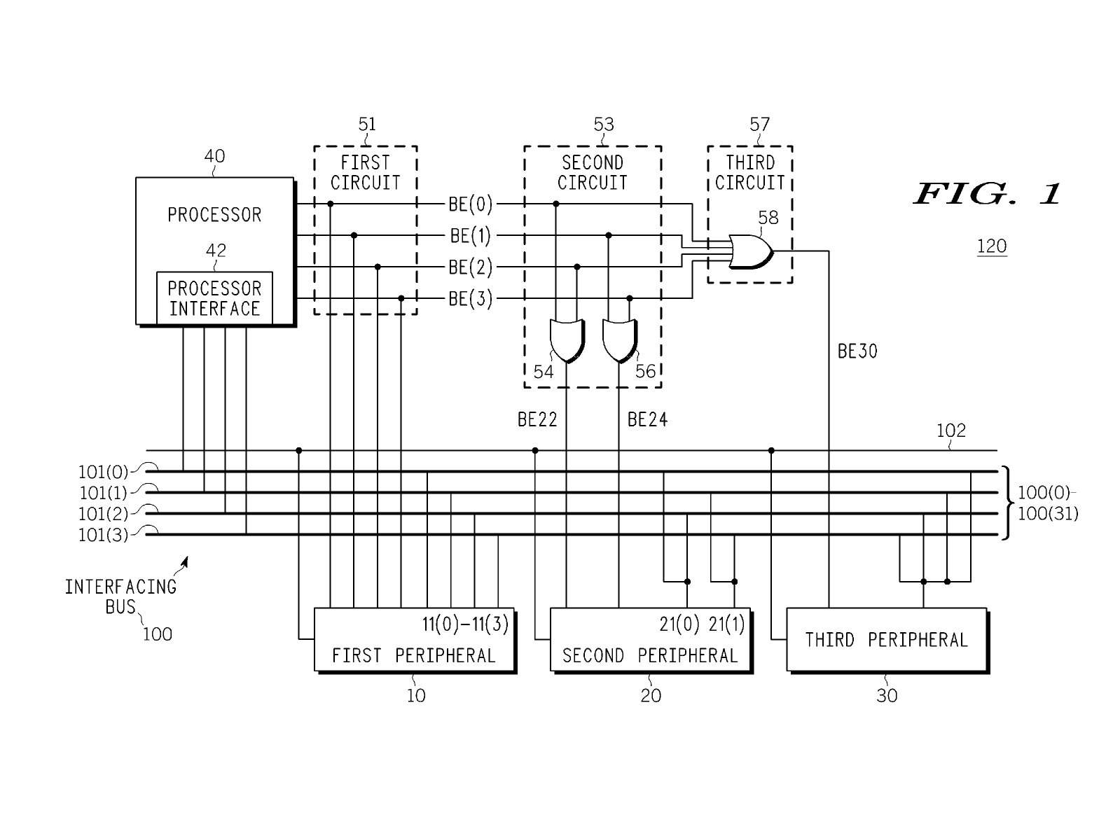

FIG. 1 illustrates apparatus 120 that includes interfacing bus 100, according to an embodiment of the invention. For simplicity of explanation it is assumed that the interfacing bus 100 is thirty-two bit wide. This is not necessarily so and interfacing buses of other widths can be used.

It is noted that in addition to the thirty-two bits of data that interfacing bus 100 also conveys control signals and address signals, although these signals can be conveyed in other means. The control signals may include READ/WRITE signals as well as byte enable signals indicating the amount of data being transferred as well as the location of the conveyed data.

Interfacing bus 100 has thirty-two data bits 100(0)-100(31) and it operates at a little endian mode. These thirty-two bits are arranged in multiple portions such as four bytes 101(0)-101(3).

The interfacing bus 100 is connected to multiple slave devices such as first peripheral 10, a second peripheral 20, a third peripheral 30. The interfacing bus 100 is also connected to a master device such as processor 40. In addition, the processor 40 and the peripherals 10-30 are connected to a byte enable logic 50. All peripherals operate in a little endian mode.

In addition, the interfacing bus 100 includes multiple address bits collectively denoted 102, for conveying an address of a peripheral associated with a data transfer.

The first peripheral 10 has a bus width (also referred to as an interface width or slave device width) of thirty-two bits that are arranges in four bytes 11(0)-11(3). Each bit of the interface of the first peripheral is connected to a corresponding interface data bit 100(0)-100(31). For simplicity of explanation four lines, each representing a byte, illustrate this connection.

The second peripheral 20 has a bus width of sixteen bits that are arranged in two bytes 21(0)-21(1). The first byte 21(0) is connected in parallel to the first and third bytes 101(0) and 101(2) of interfacing bus 100, and the second byte 21(1) is connected in parallel to the second and fourth bytes 101(1) and 101(3) of interfacing bus 100, such as to receive a data word (for example a two byte word), regardless of its byte alignment. In other words the master read bus is connected twice to the slave read bus and the slave write bus is connected to one of the bytes of the master write bus.

The third peripheral 30 has a bus width of a byte 30(0). This byte 30(0) is connected in parallel to the first, second, third and fourth bytes 101(0)-101(3) of interfacing bus 100, such as to receive a data byte that is transferred over the interfacing bus, regardless of the byte to which this data byte is aligned.

The processor 40 generates one or more byte enable signals out of byte enable signals BE(0)-BE(3) 110(0)-110(3), to indicate that one or more byte of data is transferred over one or more bytes of the interfacing bus 100 including the first (least significant) byte, second byte, third byte and the fourth (most significant) byte of the interfacing bus 100. More than a single byte enable signal can be asserted when a multiple byte data is transferred over the interfacing bus 100.

Each of the peripherals is connected to the interfacing bus 100 via a device interface. For simplicity of explanation a single box describes each peripheral and its corresponding interface.

The processor 40 has a processor interface 42 for duplicating data over the interfacing bus 100, according to the data access size. If, for example the processor 40 has to write a data byte then interface 42 duplicates the data byte four times, such that each byte of the interfacing bus 100 conveys that data byte. If, for example the processor 40 has to write a data word then the processor interface 42 duplicates the data word twice, such that each half of the interfacing bus 100 conveys that data word. According to another embodiment of the invention the duplication is also responsive to a connectivity of the target peripheral.

By duplicating the data at the processor interface 42, a single multiplexing entity is required, instead of utilizing multiple multiplexers for swapping data, thus greatly reducing the complexity as well as the space of the devices. It also provides a faster device.

The byte enable signals BE(0)-BE(3) are provided to the byte enable logic 50 that in turn sends corresponding control signals to the peripherals. As the bus width of each peripheral differs from the other, the byte enable logic 50 includes three circuits, one for each peripheral.

The first circuit 51 actually sends BE(0)-BE(3) to the first peripheral 10 unchanged. Accordingly, if a 4-byte data is transferred over the interfacing bus 100 towards the first peripheral 10 then the interfacing bus 100 conveys the address ADDR_P1 of the first interface 10 over lines 102, conveys four data bytes over lines 100(0)-100(31) and the first circuit 51 provides the first peripheral 10 four byte enable signals BE(0)-BE(3) representative of a transfer of four bytes of data over 100(0)-100(31).

The second circuit 53 includes two OR gates 54 and 56, that generate to second peripheral byte enable signals BE22 and BE24, representative of a transfer of a data byte over an odd byte of the interfacing bus 100 and of a transfer of a data byte over an even byte of the interfacing bus 100, accordingly. The structure of the second circuit 53 is based upon the assumption that a data word is transferred over two consecutive bytes of the interfacing bus and that such transfer is word aligned.

Accordingly, if a data word is transferred over the interfacing bus 100 towards the second peripheral 20 then the interfacing bus 100 conveys the address ADDR_P2 of the second interface 20 over lines 102, conveys two data bytes over two consecutive bytes of the interfacing bus 100 (for example over bits 100(16)-100(31)) and the second circuit 53 provides the second peripheral 20 two second peripheral byte enable signals BE22 and BE24 representative of a transfer of two bytes of data over the interfacing bus 100.

The third circuit 57 includes an OR gate 58 that generates a third peripheral byte enable signal BE30 to the third peripheral 30 whenever a data byte is provided over any byte of the interfacing bus 100.

Accordingly, if a data byte is transferred over the interfacing bus 100 towards the third peripheral 30 then the interfacing bus 100 conveys the address ADDR_P3 of the third interface 30 over lines 102, conveys a data byte over a byte of the interfacing bus 100 (for example over bits 100(16)-100(23)) and the third circuit 57 provides the third peripheral 30 a third peripheral byte enable signal BE30 representative of a transfer of a byte of data over the interfacing bus 100.

The following tables illustrate various signals as well as data to be conveyed over the interfacing bus 100. TABLE 1 illustrates a write operation in which the processor 40 writes data to one of the peripherals. TABLE 2 illustrates a read operation in which the processor 40 reads data from, a peripheral.

The “data address” signal indicates the byte to which the data conveyed over the interfacing bus is aligned, the “access size” signal indicate the size of data conveyed over the interfacing bus. TABLE 1 also a “data inside the processor” column that indicates the data that is provided to the processor interface 42 and a “data on interfacing bus” column that represents that data that appears over the interfacing bus 100. It is noted that the bus enable signals and the pair of “data address” and “access size” convey the same information. TABLE 2 also includes a “data on peripheral” column that indicates data that is provided by the peripheral.

TABLE 1

| Data | Access | BE(0) - | Data inside | Data on |
|---|---|---|---|---|
| Address | size | BE(3) | processor | interfacing bus |
| 00 | Byte | 0001 | 000A | AAAA |
| 01 | Byte | 0010 | 00A0 | AAAA |
| 10 | Byte | 0100 | 0A00 | AAAA |
| 11 | Byte | 1000 | A000 | AAAA |
| 00 | Word | 0011 | 00AB | ABAB |
| 10 | Word | 1100 | AB00 | ABAB |
| 00 | Long | 1111 | ABCD | ABCD |
| | word | | | |

TABLE 2

| Data | Access | BE(0) - | Data on | Data on |
|---|---|---|---|---|
| Address | size | BE(3) | peripheral | interfacing bus |
| 00 | Byte | 0001 | A | AAAA |
| 01 | Byte | 0010 | A | AAAA |
| 10 | Byte | 0100 | A | AAAA |
| 11 | Byte | 1000 | A | AAAA |
| 00 | Word | 0011 | AB | ABAB |
| 10 | Word | 1100 | AB | ABAB |
| 00 | Long | 1111 | ABCD | ABCD |
| | word | | | |

By duplicating the data provided by the peripheral the memory space of the peripheral can be aligned to the peripheral bus width, regardless of the usually wider interfacing bus.

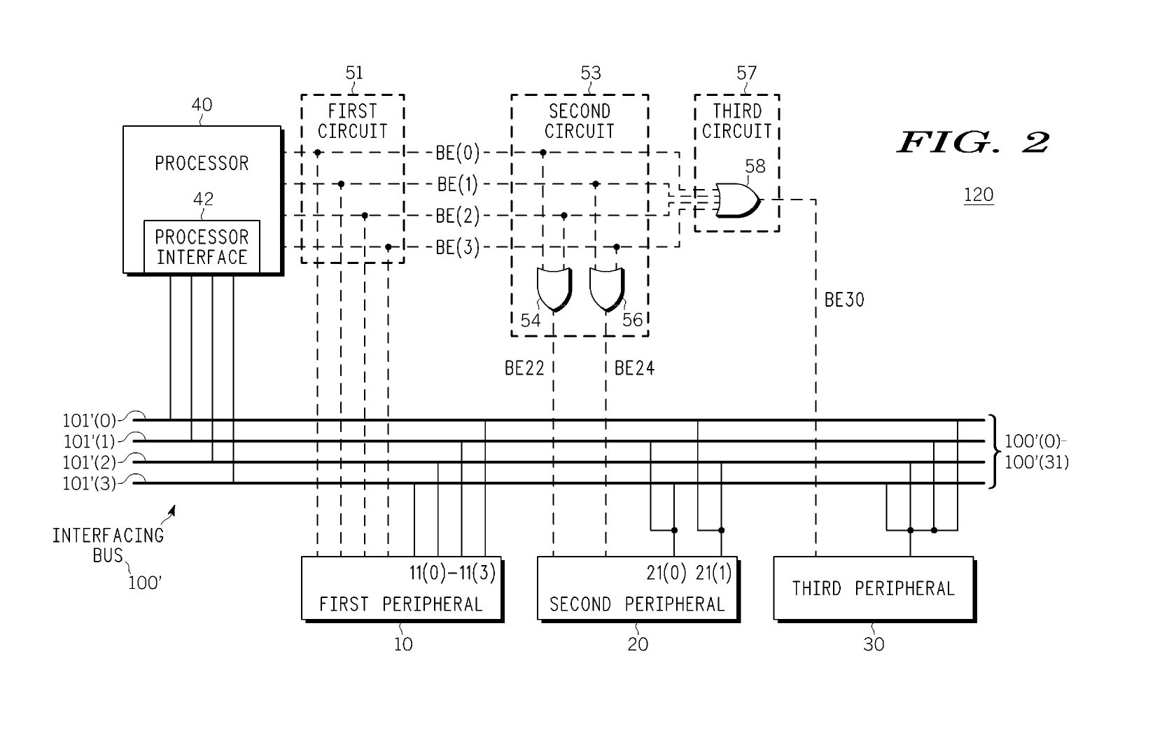

FIG. 2 illustrates an apparatus 130 that includes interfacing bus 100′, according to another embodiment of the invention. The interfacing bus 100′ has thirty-two data bits 100′(0)-100′(31) arranged in four bytes 101′(0)-101′(3).

Interfacing bus 100′ operates at a big endian mode while the peripherals 10, 20 and 30 that are connected to the interfacing bus 100′ operate at little endian mode. Accordingly, the peripherals are connected to the interfacing bus 100′ in a swapped formation. For example, bytes 11(0)-11(3) of the first peripheral 10 are connected to bytes 101′(3)-101′(0) of the interfacing bus 100′; byte 21(0) of the second interface 20 is connected in parallel to bytes 101′(1) and 101′(3) of the interfacing bus 100′ while byte 21(1) of the second interface 20 is connected in parallel to bytes 101′(0) and 101′(2) of the interfacing bus 100′.

It s noted that although FIG. 1 and FIG. 2 illustrate peripherals that have the same endian mode but different bus widths this is not necessarily so. An interfacing bus can interface between peripherals that operate at different endian modes and also interface between peripherals of the same interface width.

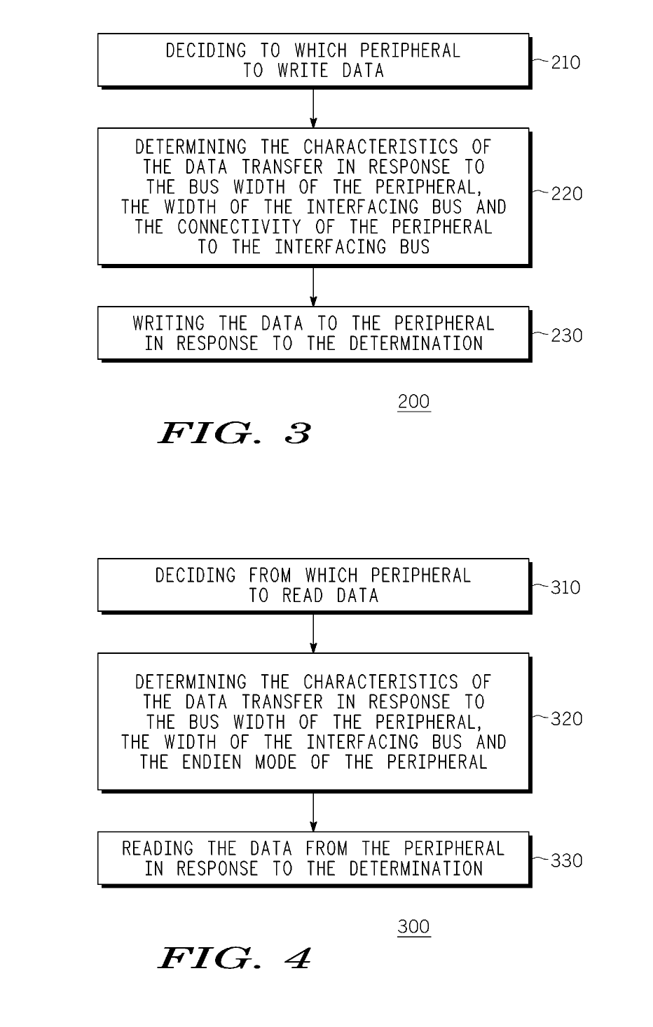

FIG. 3 is a flow chart illustrating a method 200 for conveying data over interfacing bus 100, according to an embodiment of the invention. For simplicity of explanation it is assumes that processor 40 operates as an interfacing bus master that writes data to a certain peripheral, such as third peripheral 30, that in turn operates as an interfacing bus slave.

Method 200 starts by stage 210 of deciding to which peripheral to write data. Referring to the example set forth in FIG. 1, the decision is usually dictated by software executed by processor 40.

Stage 210 is followed by stage 220 of determining the characteristics of the data transfer in response to the bus width of the peripheral, the width of the interfacing bus and the connectivity of the peripheral to the interfacing bus.

If the bus of the peripheral is narrower than the interfacing bus than the processor interface 42 has to duplicate data. This stage also includes determining which control signals such as byte enable signals, to send during the write operation.

Referring to the previous assumption, the width of third peripheral 30 is a byte, thus the processor interface 42 has to duplicate the data byte four times. Furthermore, the byte enable signals are provided to a single OR gate such that regardless of the alignment of the data byte, and regardless of the endian mode of the peripheral, the third interface will receive a third interface byte enable signal BE30 representative of a transfer of a byte of data over the interfacing bus 100.

Stage 220 is followed by stage 230 of writing the data to the peripheral in response to the determination. Referring to the previously mentioned example, processor 40 sends ADDP3 over bits 102 of the interfacing bus 100, asserts a WRITE signal (not shown), the processor interface 42 duplicates the data byte four times, and the third peripheral 30 receives BE30 and reads that data byte.

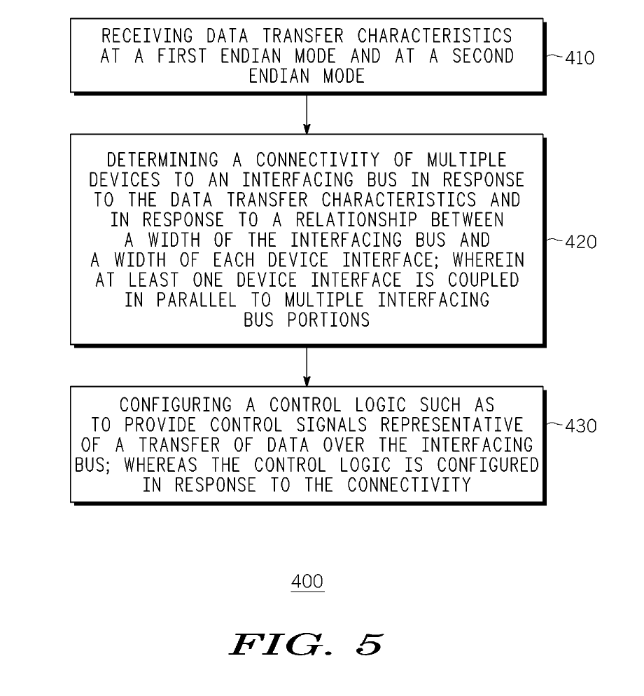

FIG. 4 is a flow chart illustrating a method 200 for conveying data over interfacing bus 100, according to another embodiment of the invention. For simplicity of explanation it is assumes that processor 40 operates as an interfacing bus master that reads data from a certain peripheral, such as second peripheral 20, that in turn operates as an interfacing bus slave.

Method 300 starts by stage 310 of deciding from which peripheral to read data. Referring to the example set forth in FIG. 1, the decision is usually dictated by software executed by processor 40.

Stage 310 is followed by stage 320 of determining the characteristics of the data transfer in response to the bus width of the peripheral, the width of the interfacing bus and the endien mode of the peripheral.

Due to the duplication of data provided by the peripheral the processor interface 42 only has to decide which bits of the interfacing bus to read and which to ignore. This stage also includes determining which control signals such as byte enable signals, READ signals and the like to send during the read operation. The duplication is done by connecting the data bits, not any logic (as in the master interface). A master device (such as a processor) should not decide which bits to read according to the slave bus width and the like it can read the data as usually as the connectivity guarantees that the data is provided along the appropriate bits.

Referring to the previous assumption, the width of second peripheral 20 is a word and that word is duplicated twice, thus the processor interface 42 has to decide which byte pair of the interfacing bus 100 to read. Furthermore, the byte enable signals BE(0)-BE(3) are provided to two OR gate such that regardless of the alignment of the data word, the second interface 20 will receive two second interface byte enable signals BE22 and BE24 representative of a transfer of a data word over the interfacing bus 100.

Stage 320 is followed by stage 330 of reading the data from the peripheral in response to the determination. Referring to the previously mentioned example, processor 40 sends ADDP2 over bits 102 of the interfacing bus, the processor interface 42 reads for example the least significant word of the interfacing bus, sends a READ signal as well as BE22 and BE24 signals to the second peripheral 20 that in turn provides a data word to be duplicated and provided to the interfacing bus 100.

FIG. 5 is a flow chart illustrating a method 400 for bus matching, according to an embodiment of the invention. Conveniently, method 400 is executed during the design stages of the integrated circuit.

Method 400 starts by stage 410 of receiving data transfer characteristics at a first endian mode and at a second endian mode. This characteristic can include the identity of bus interface portions that convey the data. When the interfacing bus 100 is an address aligned bus, such as a SRS IP BlueSky bus, the address of the interfacing bus portion to which the data is aligned is generated by the master interfacing bus device and sent over the interfacing bus. This address can be interpreted in different manners by devices that operate at different endian modes.

Stage 410 is followed by stage 420 of determining a connectivity of multiple devices to an interfacing bus in response to the data transfer characteristics and in response to a relationship between a width of the interfacing bus and a width of each device interface; wherein at least one device interface is coupled in parallel to multiple interfacing bus portions. Referring to the example set forth in FIG. 1 and FIG. 2 the connectivity of the devices and especially the slave devices allows to transfer data of different sizes over the interfacing bus, regardless of the endian mode of the bus.

Stage 420 is followed by stage 430 of configuring a control logic such as to provide control signals representative of a transfer of data over the interfacing bus; whereas the control logic is configured in response to the connectivity. Referring to the example set forth in FIG. 1 and FIG. 2, the control logic generates control signals such as BE30, BE22 and BE24 to indicate the size of the transferred data whereas these control signals are driven from byte enable signals in a manner that is responsive to the connectivity of the slave devices.

The inventors applied the method at a system on chip that is included within a cellular phone. The system on chip includes multiple processors that can operate at big endian mode as well as little endian mode. The endian mode of the processors, when communication between themselves or when communicating with internal devices (such as memory blocks) can vary but the communication between the processors and external devices such as peripherals, that are connected over an interfacing bus, remains unchanged.

The invention facilitates connecting old (legacy) peripherals that typically have a narrow bus to modern processors that typically have a larger bus.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A method for bus matching, the method comprising the steps of:
receiving data transfer characteristics of a first endian mode data transfer and of a second endian mode data transfer;
determining a connectivity of multiple devices to an interfacing bus in response to the data transfer characteristics and in response to a relationship between a width of the interfacing bus and a width of each device interface; wherein at least one device interface is coupled in parallel to multiple interfacing bus portions; and
configuring a control logic such as to provide control signals representative of a transfer of data over the interfacing bus; whereas the control logic is configured in response to the connectivity.

2. The method of claim 1 wherein the step of determining a connectivity of a certain device is responsive to a relationship between an interfacing bus endian mode and an endian mode of the certain device.

3. The method of claim 1 wherein the data transfer characteristics comprise an identity of at least one interfacing bus portion that conveys data during a data transfer.

4. The method of claim 1 further comprising configuring a master device interface such as to duplicate data to be provided to a slave device over the interfacing bus if a bus of the slave device is narrower than the interfacing bus.

5. An apparatus comprising:
an interfacing bus characterized by an interfacing bus width;
a master device, coupled to the interfacing bus, whereas the master device comprises a master device interface;
multiple slave devices, each slave device coupled to the interfacing bus and comprising a slave device interface; wherein at least one slave device interface is coupled in parallel to multiple interfacing bus portions; and
control logic, coupled to the interfacing bus and to the master device, the control logic is adapted to provide control signals representative of a transfer of data over the interfacing bus; whereas the control logic is configured in response to a connectivity of the multiple slave devices to the interfacing bus; whereas said connectivity is responsive to data transfer characteristics and is responsive to relationships between a width of the interfacing bus and a width of each device interface.

6. The apparatus of claim 5 wherein the master device interface is adapted to selectively duplicate data to be transferred to a slave device in response to a relationship between the interfacing bus width and the width of the slave device interface.

7. The apparatus of claim 5 wherein the data transfer characteristics reflect data transfer over the interfacing bus at a first endian mode and at a second endian mode.

8. The apparatus of claim 5 wherein the apparatus is a cellular phone.

9. A method comprising:
selecting a slave device and a master device to be involved in a data transfer over an interfacing bus;
determining characteristics of the data transfer in response to a width of the slave device, a width of the interfacing bus, and a connectivity of the slave device and the master device to the interfacing bus; whereas the interfacing bus is coupled to multiple slave devices and wherein at least one slave device comprises an interface that is coupled in parallel to multiple interfacing bus portions; and wherein said connectivity is responsive to an endian mode of the slave device and the interfacing bus; and
transferring the data in response to the determined characteristics.

10. The method of claim 9 wherein the data transfer characteristics comprise an identity of at least one interfacing bus portion that conveys data during a data transfer.

11. The method of claim 9 further comprising configuring a master device interface such as to duplicate data to be provided to a slave device over the interfacing bus if a bus of the slave device is narrower than the interfacing bus.
